(19) United States
(12) Patent Application Publication
(10) Pub. No.: US 2025/0292705 A1
(43) Pub. Date: Sep. 18, 2025

(54) A DEVICE FOR DISPLAYING A SHPERICAL OBJECT IN A FLAT PLANE

(71) Applicant: Cornelis Johannes Van De Werdt, Veendam (NL)

(72) Inventor: Cornelis Johannes Van De Werdt, Veendam (NL)

(21) Appl. No.: 18/862,687

(22) PCT Filed: May 4, 2023
(86) PCT No.: PCT/NL2023/050243

§ 371 Date: Nov. 4, 2024

(30) Foreign Application Priority Data
May 4, 2022 (NL) 2031772

(51) Int. Cl. G09B 29/02; G09B 27/08; G09B 29/10; G09B 29/14

(52) U.S. Cl. CPC G09B 29/02; G09B 27/08; G09B 29/10; G09B 29/14

(57) ABSTRACT

The invention relates to a device for displaying a spherical object on a flat plane, characterized in that the device comprises a first disc with a projected image of the surface of a first hemisphere of the spherical object, and at least two second discs with a projected image of the surface of a second hemisphere of the spherical object. A preferred embodiment is a method for navigation, comprising the use of the device according to the invention, and a method for determining the time at any point in the world, comprising the use of the device according to the invention.

The present invention relates to a device according to the preamble of claim 1. The device is suitable for displaying an image of a spherical object in a flat plane. For example, the device is suitable for displaying the surface of the Earth in a flat plane. Additionally, the device proves to be suitable for indicating time at any point on Earth. A particular application of the device according to the invention is to display an image of the interior of a spherical object, such as the starry sky, in a flat plane. This makes the device highly suitable for use in digitally controlled navigation.

Such an invention is not known in the art. There are several known ways to display the Earth's surface in map form. The underlying principle is always to display the entire surface on a single map. Furthermore, an alternative method has been devised and is described in Dutch patent NL 2001144. That patent describes a new method for displaying an image of a spherical object in a flat plane, such that desired areas are displayed with minimal distortion. This method will hereinafter be referred to as the Van de Werdt method.

This well-known Van de Werdt method provides excellent results in displaying desired parts of a spherical surface in a flat plane. The land areas of the Earth can be particularly well and accurately displayed using this method. Implementation in a computer provides a continuously adjustable and scalable method for displaying the image using the Van de Werdt method. However, the known map provides only a static image when used physically.

In the art, no solution is known for providing an adjustable display of the surface of a sphere, such as the Earth, in a flat plane using a physical device.

The present invention now aims to provide a device capable of displaying an adjustable representation of the surface of a sphere, such as the Earth, in a flat plane.

The invention particularly aims to provide a device of the aforementioned kind that shows the entire surface of the sphere in a square flat plane.

Specifically, the invention aims to provide a device of the aforementioned kind that can adjust the display according to the user's position.

Additionally, the invention aims to provide a method for navigation.

The invention also aims to provide a method for determining the time at any location on Earth.

To achieve at least one of the aforementioned advantages, the invention, according to a first embodiment, provides a device containing the features of claim 1. This device allows displaying an image on the surface of a spherical object in a flat plane, where the positioning of the image on the flat plane can be adjusted as desired.

Furthermore, it has been found that the device allows for easily determining the time at any point on Earth. The device can also be used for navigation. Such synergistic operation is a significant advantage and leads to simplified navigation.

Therefore, the invention relates to a device for displaying a spherical object in a flat plane, characterized in that the device comprises a first disc with a projected image of the surface of at least one first hemisphere of the spherical object, and at least two second discs, each with a projected image of the surface of at least one second hemisphere of the spherical object, wherein the first and second hemispheres together display the entire surface of the spherical object. This device provides the possibility to align the position of the Earth in the device in any desired direction, depending on where a user stands around the device. This allows for an optimal display of the Earth's surface in a flat plane. More specifically, a square image is obtained, which inherently provides a more faithful representation than the rectangular image that is currently almost exclusively used in practice. Particularly when using the Van de Werdt method, an unparalleled display in the flat plane is achieved, particularly with the ability to accurately depict the land surface through a projection that can be referred to as an orthographic projection.

In practice, the first half of the spherical object is effectively depicted on a first circular disc, and the second half of the spherical object is depicted on a plurality of second circular discs, for example, preferably four, which are symmetrically placed around the first disc. The central disc can be, mechanically or digitally, linked to each of the other discs at the outer circumference in such a way that a rotation of the central disc causes the other discs to rotate in the opposite direction, ensuring that regardless of the position of the central disc in the flat plane, the other discs are aligned with the image on the first disc.

When displaying the Earth's surface, it is preferred that the northern hemisphere is displayed on the first disc due to the significant land area in the northern hemisphere, and the southern hemisphere is displayed on the second discs. To accurately represent the largest portions of the southern hemisphere relative to the northern hemisphere, it is preferred that specifically South America, Africa, and Oceania are depicted on separate second discs relative to the first disc. Therefore, a device with at least three second discs is preferred.

As a general rule, it is preferred that the at least two, or in other words, the plurality of second discs, are positioned symmetrically around the circumference of the first disc. This generally provides an optimal representation of the image of the spherical object in the flat plane. However, when the spherical object is the Earth, it may be preferable to project the display according to the Van de Werdt method, in which case the positioning of the second discs is made dependent on the positioning of the land areas on the first disc.

Within the invention, a faithful representation can be achieved when the circumference of the at least two second discs is aligned with the image on the spherical object against the circumference of the first disc. This ensures a seamless continuation of the image from the first hemisphere displayed on the first disc to the corresponding and continuing part of the image displayed on the second hemispheres on the second discs. The two diagonals of the square flat plane where the device displays the image are both pure lines of the Earth's circumference in two longitude lines shifted by 90°, for example, passing through Greenwich/GB and Memphis/US. In the case of displaying the Earth on the discs of the device according to the invention, a faithful representation is achieved.

A suitable display on the device is achieved when it includes four second discs positioned symmetrically around the first disc, which can be referred to as the Maroga projection. This provides the advantage of obtaining a highly faithful representation of the entire surface of the spherical object in a square flat plane. With this device according to the invention, the effect is also achieved, as indicated in the preamble, of displaying a highly accurate image of, for example, the surface of a planet such as Earth in the flat plane. Due to the nature of the image with a centrally placed first hemisphere on a circle and four circles symmetrically placed around the outer circumference of this circle, each depicting a part of the second hemisphere, a square flat plane is obtained with an image of the spherical object. A square flat plane with the first circle as the center and the vertices at the centers of the four second circles represents a pure representation in two diagonals of the square flat plane. This type of image, for example, of Earth, is completely different from the regular image that uses the equator as a pure line. The present invention includes two pure lines, resulting in a more accurate representation.

As mentioned above, it is preferred that the spherical object displayed on the device according to the invention is the Earth.

When displaying the Earth, it is preferred that the center of the first disc includes either the North Pole or the South Pole, and the centers of the at least two second discs include the other pole.

To adjust the position of the first disc as desired and maintain the correct alignment of the second discs with respect to the first disc, it is preferred that the first disc and the at least two second discs are each rotatable about their own axis of rotation and are interconnected to provide opposite rotation of the first disc relative to each of the at least two second discs. If the device includes four second discs, with each revolution of the first disc over 90° and symmetric depiction and positioning of the second discs, a correct alignment of the invention can be achieved.

A simple alignment is achieved when the diameter of the first disc and each second disc is identical. The diameter of a disc is equal to half the circumference of the spherical object.

The device according to the invention provides direct rotation of each disc when the first disc and the at least two second discs are equipped with a mutually cooperating mechanism, such as interlocking gears, to induce rotation of each disc when one of the other discs rotates. Each second disc is in direct engagement with the first disc. As mentioned above, such coupling can also be achieved digitally, eliminating the need for mechanical gears.

An addition to the device described above consists of a time division ring, with its center aligned with the center of the first disc and its inner edge preferably located outside the second discs. The ring can be rotated around the aforementioned second discs, and the time division can be set to correspond to the correct time on the Earth's image aligned within the ring.

In particular, it is preferred that the ring interacts with the outer circumference of the at least two second discs to induce rotation of the ring when one of the other discs rotates.

The time division on the ring is preferably an even distribution of 24 hours.

An optional improved representation of the image can be achieved by a device that includes a first disc and a number of second discs arranged symmetrically around the first disc, with a pyramid-shaped prism consisting of a square base and triangular faces extending from each base edge, positioned above the first disc, and with their far corner located above the center of the base, and wherein the vertices of the bottom face are respectively positioned at the centers of the second discs. The number of base edges and the number of corner points connecting these base edges are equal to the number of second discs. In particular, the device is preferably composed of a first disc and four second discs arranged symmetrically around the first disc, wherein a prism consisting of a square base and triangular faces extending from each edge of the base and with their vertices remote from the base located above the center of gravity of the base is positioned above the first disk and the four vertices are respectively are positioned at the centers of the second discs. The prism-shaped deformation of the image provides a more uniform representation, especially in the transition from the first disc to the second disc. The pyramid provides a virtual 3D representation of the image on the square flat plane. The height of the pyramid is 50% of the length of the edges of the square flat plane.

Furthermore, the invention relates to a method for navigation, comprising the use of the device according to the invention.

The invention also relates to a method for determining the time at any point on the Earth, comprising the use of the device according to the invention with a time division ring as mentioned above.

The invention will be explained in more detail below with reference to a drawing. The drawing shows in:

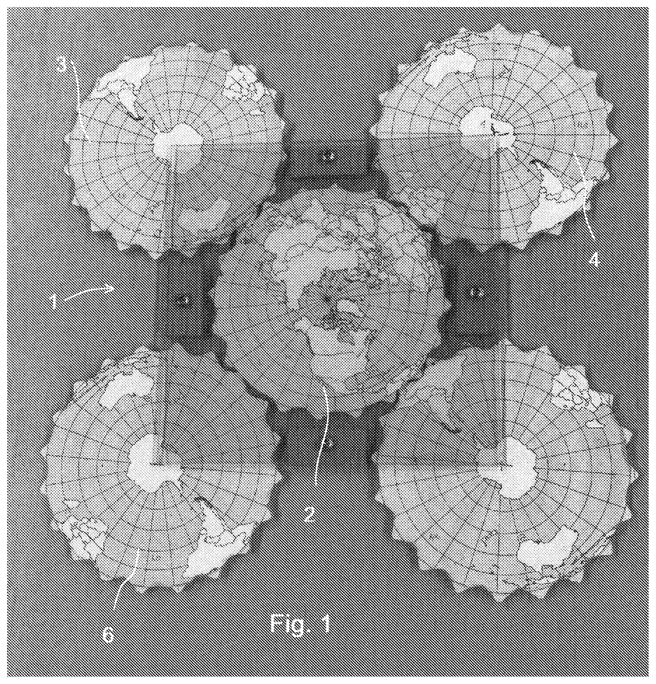

FIG. 1 a first view of a device according to the invention,

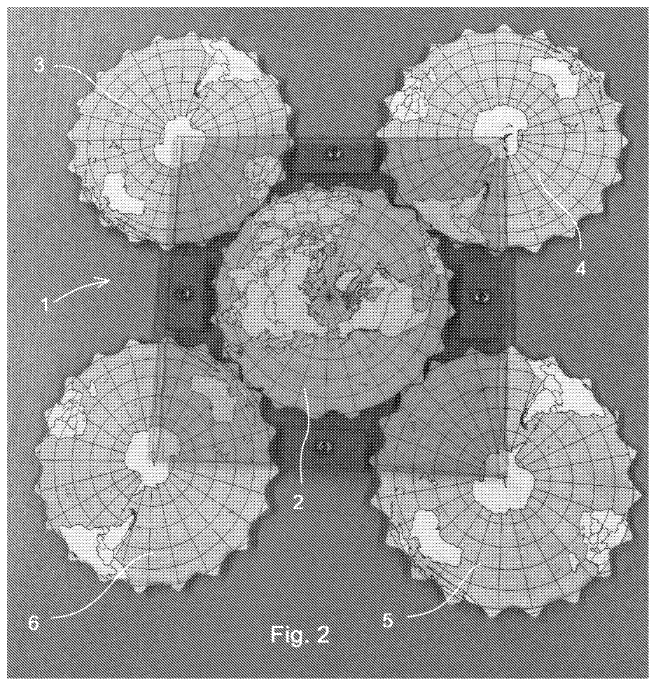

FIG. 2 a second view of a device according to the invention,

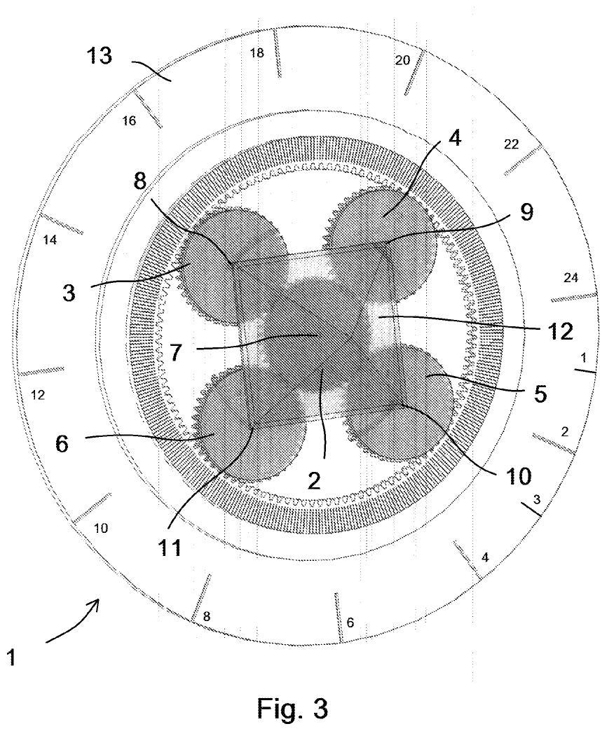

FIG. 3 a variant of a device according to the invention.

In the figures, the same parts are designated by the same reference numerals. However, not all parts necessary for a practical implementation of the invention are shown, for simplicity of presentation.

FIG. 1 shows a first view of a device 1 comprising a first disc 2 and four second discs 3, 4, 5, 6 positioned symmetrically around the first disc 2. The first disc 2 is rotatable about the center point 7. At the circumference, the first disc 1 is operatively coupled to the circumference of the second discs, such that a rotation about the center point 7 causes a rotation of the second discs 3, 4, 5, 6 around their respective center points 8, 9, 10, 11.

The image on the device shown in FIG. 1 and FIG. shows the northern hemisphere on the first disc 2 and the southern hemisphere on the second discs 3, 4, 5, 6. The equator lies on the circumference of both the first and second discs. The second discs 3, 4, 5, 6 are positioned relative to the first disc such that in the variant according to FIG. 1 at each point of contact of the first disc 2 with each of the second discs an accurate and faithful and accurate positioning or alignment with the image of the second discs is obtained. North America on the first disc 2 is aligned with South America on the second disc 5.

By rotating the first disc 2 in the direction of FIG. 2, after some turning, North America on the first disk 2 is aligned with South America on the second disk 4. Further rotation continuously changes the alignment of the matching parts of the images of the first disk with the respective second disk. Depending on how the user is oriented in relation to the true north pole, rotating the discs allows him to choose a highly accurate direction for displaying the image in the flat plane of the device 1.

Finally, FIG. 3 shows a variant of the image in which a pyramid-shaped prism 12 is placed on the device 1. The pyramid-shaped prism 12 has a square bottom face and triangular faces extending from each edge of the bottom surface, with their vertices remote from the bottom face located above the center of gravity of the bottom face. The center of gravity of the bottom face is placed above the center point 7 of the first disc 2 such that the four vertices are respectively positioned on the centers 8, 9, 10, 11 of the second discs 3, 4, 5, 6. The prismatic deflection of the image produces a smoother image especially at the transition from the first disc to the second disc.

A disc 13 with a time indication, also indicated as time division ring, is placed on the periphery of the device 1. The time designation of 1-24 corresponds to the number of hours distributed around the earth. By aligning the time indication on the disc 13 with a known combination of time and place, the correct time can be displayed instantaneously for any part of the earth.

The invention is not limited to the embodiments described above and shown in the figures. The invention is limited only by the appended claims.

The invention also extends to any combination of features described above independently of each other.

1-16. (canceled)

17. A device for displaying a spherical object on a flat plane, wherein the device comprises a first disc with a projected image of the surface of at least one first hemisphere of the spherical object, and at least two second discs, each with a projected image of the surface of at least one second hemisphere of the spherical object, wherein the first and second hemispheres together represent the entire surface of the spherical object.

18. The device according to claim 17, wherein the device comprises at least three second discs.

19. The device according to claim 18, wherein the at least three second discs are symmetrically positioned around a perimeter of the first disc.

20. The device according to claim 17, wherein a perimeter of the at least two second discs is aligned with a depiction on the spherical object against a perimeter of the first disc.

21. The device according to claim 18, wherein the device comprises four second discs.

22. The device according to claim 17, wherein the spherical object represents the Earth.

23. The device according to claim 22, wherein a center of the first disc includes one of the group consisting of North Pole and South Pole, and a center of the at least two second discs includes the South Pole.

24. The device according to claim 17, wherein the first disc and the at least two second discs are individually rotatable about their own axes and are coupled together to provide opposite rotation of the first disc with respect to each of the at least two second discs.

25. The device according to claim 24, wherein a diameter of the first disc and each second disc is identical.

26. The device according to claim 17, wherein the first disc and the at least two second discs are equipped with a mutually cooperating mechanism to induce rotation of each disc when one of the other discs rotates.

27. The device according to claim 26, wherein the mutually cooperating mechanism comprises interlocking gears.

28. The device according to claim 17, additionally comprising a time division ring, with its center aligned with the center of the first disc.

29. The device according to claim 28, wherein the time division ring comprises an inner edge located outside the at least two second discs.

30. The device according to claim 28, wherein the time division ring interacts with an outer circumference of the at least two second discs to induce rotation of the time division ring when one of the other discs rotates.

31. The device according to claim 28, wherein the time division ring comprises an even distribution of a number of hours selected from the group consisting of 12 hours and 24 hours.

32. The device according to claim 17, wherein the at least two second discs are arranged symmetrically around the first disc, and wherein a pyramid shaped prism, comprising a square base and triangular faces extending from each edge of the square base and with their vertices remote from the square base located above a center of gravity of the square base, is positioned above the first disc and with corner points of the square base respectively positioned on centers of the at least two second discs.

33. A method for navigation, comprising providing a device according to claim 17 and using the device to navigate.

34. A method for determining the time at any point in a world, comprising providing a device according claim 31 and using the device to determine the time at any point in the world.
